(19) United States
(12) Patent Application Publication
(10) Pub. No.: US 2015/0287511 A1
(43) Pub. Date: Oct. 8, 2015

(54) CONNECTOR DEVICE

(71) Applicant: YAZAKI CORPORATION, Tokyo (JP)

(72) Inventor: Shouichi FURUKAWA, Shizuoka (JP)

(21) Appl. No.: 14/676,968

(22) Filed: Apr. 2, 2015

(30) Foreign Application Priority Data
Apr. 4, 2014 (JP) 2014-077649

(51) Int. Cl. H01F 27/04; H01F 27/36; H01F 27/33; H01F 27/29; H01F 27/28

(52) U.S. Cl. CPC H01F 27/04; H01F 27/29; H01F 27/288; H01F 27/33; H01F 27/36

(57) ABSTRACT

In a connector device, a first terminal connecting part of a shield plate mounting coils is crank-shaped with a first bending part and a second bending part. Under an accommodating condition that the shield plate is accommodated in an inside space of a housing, a tip portion of the first terminal connecting part is exposed by penetrating through a through-hole of the housing to a connector part, and a first locking part of the shield plate is locked to a second locking part of the housing. Consequently, even if the shield plate moves relatively to the housing in the inserting direction of the shield plate into the housing, it is possible to prevent stress from concentrating on the first bending part and the second bending part, which are present between the tip portion positioned in the housing at the through-hole and a resinous member of the shield plate.

### CROSS REFERENCE TO RELATED APPLICATIONS

The present application is based on, and claims priority from Japanese Patent Application No. 2014-077649, filed Apr. 4, 2014, the disclosure of which is hereby incorporated by reference herein in its entirety.

### TECHNICAL FIELD

The present application relates to a connector device for extracting a part of a busbar of a circuit body where the busbar is insert-molded in resinous material to expose the busbar to a connector part.

### BACKGROUND

For instance, in a case of employing a choke coil for smoothing current or filtering noise in a high-current powered instrument, a choke coil is mounted on a metal-core substrate having a metal plate as an inner layer, to deal with high current flowing through the coil (refer to JP 2008-140801 A). The metal-core substrate is a circuit body in which a busbar is insert-molded in a resinous member. The metal-core substrate mounting the choke coil is accommodated in a shield housing for noise isolation.

In this case, the electrical connection to the choke coil on the metal-core substrate accommodated in the shield housing is embodied in a connector part formed outside the shield housing. Concretely, it is performed to allow part of the busbar, which projects from the resinous member of the metal-core substrate, to penetrate through the shield housing so that the busbar is partially exposed to the connector part. With the arrangement, an object to be connected to the choke coil is fitted into the connector part, so that the electrical connection between the busbar and the object is realized in the connector part.

Meanwhile, to ensure a space for accommodating the metal-core substrate mounting the choke coil, it is rational to arrange the metal-core substrate so as to abut on any inner wall of the shield housing in view of avoiding the scale-up in size of the shield housing as possible.

When allowing the terminal connecting part of the busbar, which projects from the resinous member of the so-arranged metal-core substrate, to penetrate through the shield housing and thus extracting the terminal connecting part out of the shield housing, the so-extracted terminal connecting part will be brought into a position near the shield housing's inner wall in abutment with the metal-core substrate. Namely, the position of the terminal connecting part extracted out of the shield housing is biased in the height direction of the shield housing (i.e. direction to mount the choke coil on the metal-core substrate).

When the position of the terminal connecting part is biased in this way, the connector part protecting the terminal connecting part has to be shaped so as to protrude outside the shield housing in comparison with the shield housing's inner wall in abutment with the metal-core substrate. Such a shape is undesirable since it can complicate the molding of the shield housing, as well as reducing the housing strength around the connecting part.

Accordingly, it is preferable to bend the busbar in the shield housing so that the busbar penetrates through the shield housing at a point as close to the housing center in the height direction of the shield housing as possible.

### SUMMARY

As mentioned above, in the case of bending, in the shield housing, the busbar of the metal-core substrate accommodated in the shield housing and subsequently extracting the busbar into the connector part, if the shield housing and the metal-core substrate move relatively to each other, there is a possibility that the stress concentrates on a bending part of the busbar. Especially, in case of mounting a weighing electric component, such as a choke coil, on the metal-core substrate, the stress applied to the bending part of the busbar increases due to the relative movement between the shield housing and the metal-core substrate.

Such a problem is apt to arise in a case that part of the busbar of the circuit body, in which the busbar is insert-molded in the resinous member, is extracted out of the housing accommodating the circuit body and also exposed into the connector part, but not limited to a case of accommodating the metal-core substrate in the shield housing having a noise isolating function according to the choke coil, commonly.

In the above-mentioned situation, an object of the present application is to provide a connector device which, despite that a terminal connecting part of a busbar of a circuit body where the busbar is insert-molded in a resinous member is bent in an inside space of a housing accommodating the circuit body and that a tip of the terminal connecting part is exposed to an outside through the housing, is capable of suppressing the occurrence of a relative movement between the housing and the circuit body in the inserting direction of the circuit body, which comes from stress concentration on such a bending part of the terminal connecting part.

To attain the above-mentioned object, a connector device according to an aspect of the present invention includes: a circuit body in which a busbar is insert-molded in a resinous member and on which an electric component is mounted; a housing defining an inside space in which the electric component on the circuit body is accommodated since the circuit body is inserted into the inside space through an opening of the housing; a terminal connecting part provided in the busbar, the terminal connecting part projecting from the resinous member in a crank shape and having a tip portion extending along an inserting direction of the circuit body; a connector part formed outside the housing to expose the tip portion penetrating through the housing under an accommodating condition that the circuit body is accommodated in the inside space; a first locking part provided in the circuit body; and a second locking part provided in the housing and being lockable to the first locking part. Under the accommodating condition, a relative movement of the circuit body to the housing along the inserting direction is restrained since the first locking part and the second locking part are locked to each other.

With such a constitution, under the accommodating condition that the circuit body inserted through the opening of the housing is accommodated in the inside space, the tip portion of the terminal connecting part of the busbar penetrates through the housing and is exposed into the connector part outside the housing. Then, at the penetration point of the housing, the tip portion of the terminal connecting part of the busbar is positioned in relation to the housing.

In such an accommodating condition, if the circuit body moves relatively to the housing in the inserting direction into the inside space, stress will concentrate on a crack-shaped bending part of the terminal connecting part, which is positioned closer to the circuit body than the tip potion of the terminal connecting part positioned in relation to the housing.

However, with the connector device according to the aspect of the present invention, when the circuit body is in the above-mentioned accommodating condition to the inside space, the first locking part and the second locking part are locked to each other, so that the relative movement of the circuit body to the inside space of the housing in the inserting direction of the circuit body is restrained

Therefore, it is possible to prevent such a relative movement, which comes from stress concentration on the crack-shaped bending part of the terminal connecting part, from being generated between the housing and the circuit body, in the inserting direction of the circuit body.

The circuit body may further include a press-fitting part to be press-fitted into the opening under the accommodating condition.

With such a constitution, when the circuit body is accommodated in the inside space of the housing into the accommodating condition, the press-fitting part of the circuit body is press-fitted into the opening of the housing.

Thus, due to press-fitting of the press-fitting part into the opening, in either one direction perpendicular to the inserting direction of the circuit body or two directions perpendicular to the inserting direction of the circuit body and perpendicular to each other, the relative movement of the circuit body to the inside space of the housing in the inserting direction of the circuit body is restrained. Due to frictional force produced between the press-fitting part and the opening by press-fitting, the relative movement of the circuit body to the inside space of the housing in the inserting direction of the circuit body is also restrained.

For this reason, it is possible to prevent such a relative movement, which comes from stress concentration on the crank-shaped bending part of the terminal connecting part of the housing, from being generated between the housing and the circuit body in the inserting direction of the circuit body, furthermore.

With the connector device according to the aspect of the present invention, even if the busbar insert-molded in the resinous member of the circuit body is bent to a crank shape in the inside space of the housing accommodating the circuit body and the tip portion of the so-bent busbar is exposed to an outside through the housing, it is possible to prevent such a relative movement due to stress concentration on the bending part of the busbar from being generated between the housing and the circuit body in the inserting direction of the circuit body.

### BRIEF DESCRIPTION OF DRAWINGS

FIG. 1 is an exploded perspective view of a coil unit according to an embodiment.

FIG. 2 is a side view illustrating a schematic constitution of one terminal connecting part illustrated in FIG. 1.

FIG. 3 is a sectional side view of the coil unit before inserting a shield plate where the coil of FIG. 1 is accommodated in a coil housing part.

FIG. 4A is a sectional side view of the coil unit after inserting the shield plate where the coil of FIG. 1 is accommodated in the coil housing part, and FIG. 4B is an enlarged sectional view of a part I of FIG. 4A.

FIG. 5 is a sectional top view of the coil unit after inserting the shield plate where the coil of FIG. 1 is accommodated in the coil housing part.

### DESCRIPTION OF EMBODIMENTS

Hereinafter, a coil unit 1 as a connector device according to an embodiment will be described with reference to the drawings.

The embodiment will be explained with illustration where the connector device applied to a choke coil unit which is used as a noise filter in a circuit with higher current of a vehicle, such as electric vehicle (EV) or hybrid vehicle (HEV: vehicle equipped with an engine and a motor generator).

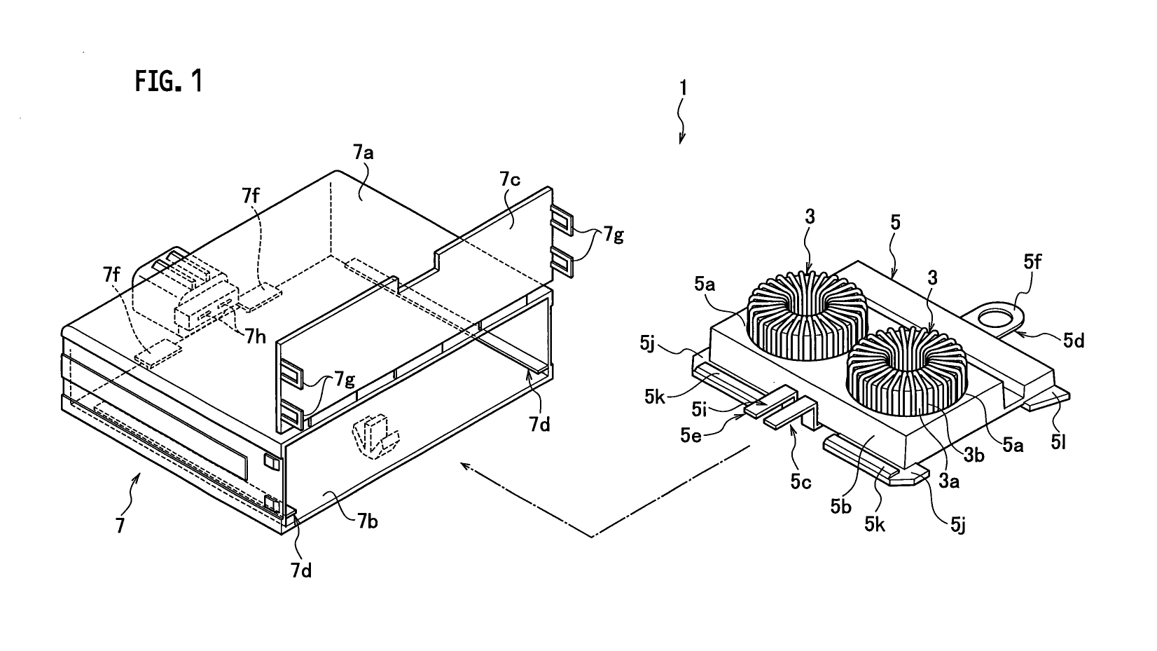

As illustrated in FIG. 1, the coil unit 1 as the connector device according to the embodiment includes two coils 3 as electric components, a shield plate 5 as a circuit body on which these coils 3 is mounted, and a housing 7 in which the shield plate 5 mounting the coils 3 is accommodated.

Each of the coils 3 is formed by an annular toroidal core 3a around which a conductive wire 3b is wound. In the respective coils 3, their lower half parts in the direction of a center axis of the toroidal core 3a are accommodated in two coil housing parts 5a formed in the shield plate 5.

The shield plate 5 is formed by insert-molding a first busbar 5c and a second busbar 5d in a rectangular resinous member 5b. The coil housing parts 5a for accommodating the coils 3 are formed on an upper surface of the shield plate 5.

In the first busbar 5c and the second busbar 5d, their significant portions are embedded in the resinous member 5b. A portion of the first busbar 5c projects from one long side of the resinous member 5b to form a first terminal connecting part 5e. A portion of the second busbar 5d projects from the other long side of the resinous member 5b to form a second terminal connecting part 5f.

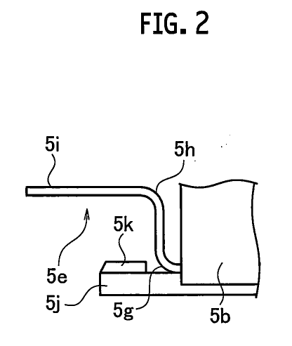

As illustrated in FIG. 2, the first terminal connecting part 5e of the first busbar 5c is crank-shaped with a first bending part 5g and a second bending part 5h. A tip portion 5i of the first terminal connecting part 5e is arranged so as to extend in parallel with the resinous member 5b. The second terminal connecting part 5f of the second busbar 5d includes a screw hole screw-fastened to an earth point (not illustrated) of a vehicle.

Both ends of the conductive wire 3b of the coil 3 inserted into each coil housing part 5a are electrically connected to the first busbar 5c and the second busbar 5d through capacitors (not illustrated), respectively. The coil 3 inserted into each coil housing part 5a is mounted on the shield plate 5 since the conductive wire 3b is electrically connected to the first busbar 5c and the second busbar 5d.

On both corners of one long side of the resinous member 5b from which the first terminal connecting part 5e of the first busbar 5c projects, respective guide parts 5j are arranged so as to project from the corners, in the form of thin plates extending in both extending directions of long and short sides. A first locking part 5k is formed at a leading end of each guide part 5j in the extending direction of the short side of the resinous member 5b.

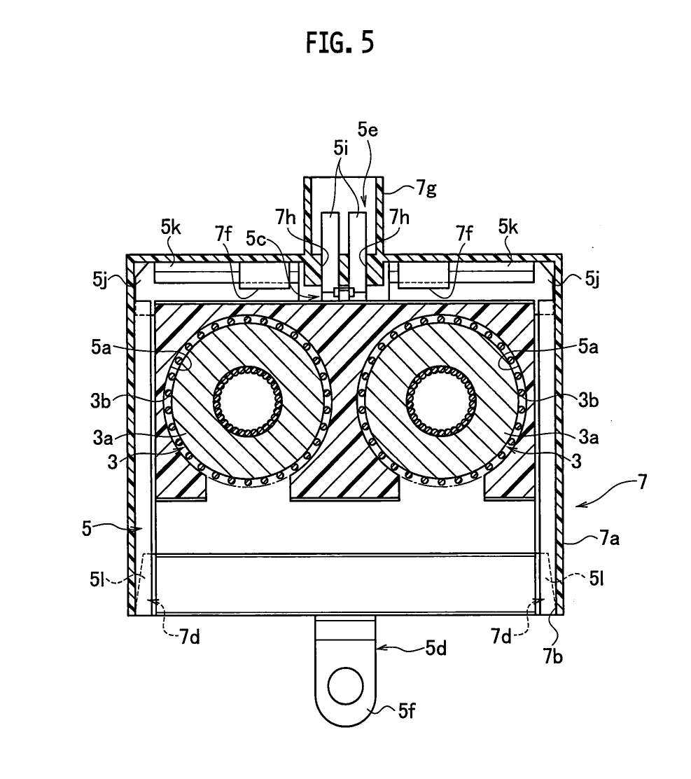

On both ends of the other long side of the resinous member 5b from which the second terminal connecting part 5f of the second busbar 5d projects, respective press-fitting parts 51 are arranged so as to project from both ends, in the form of thin plates extending in the extending direction of the long side (only one illustrated in FIG. 1, see FIG. 5). The dimension between tips of both press-fitting parts 51 in the extending direction of the long side of the resinous member is somewhat longer than the dimension between tips of both guide parts 5j in the same direction.

The housing 7 includes a main body 7a having an opening 7a through which the shield plate 5 mounting the coils 3 are to be inserted into an inside space, and a cover 7c for opening or closing the opening 7b. The opening 7b is rectangular-shaped so as to allow the passage of the shield plate 5. On inside faces of both sidewalls of the main body 7a continued to both short sides of the opening 7b, guide grooves 7d are formed in parallel with a bottom wall of the main body 7a. The guide grooves 7d guide the guide parts 5j of the resinous member 5b of the shield plate 5.

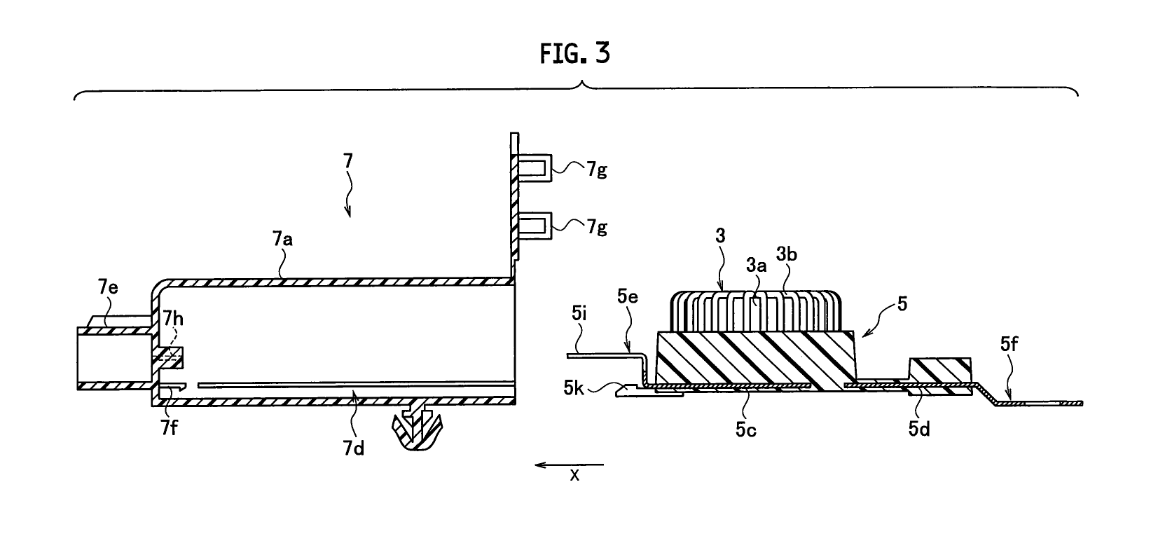

In the main body 7a, the guide grooves 7d on both sidewalls are adapted so that when inserting the shield plate 5 into the main body 7a through the opening 7b, the guide parts 5j of the shield plate 5 are guided by the guide grooves 7d in the inserting direction illustrated with arrow X of FIG. 3, respectively. Additionally, the guide grooves 7d are adapted that when inserting shield plate 5 into the main body 7a, the press-fitting parts 51 of the shied plate 5 come into pressure contact with the sidewalls of the main body 7a provided with the guide grooves 7d.

On the outside face of a wall of the main body 7a opposed to the opening 7c, a tubular connector part 7e is formed so as to project from the outside face. On the inside face of the wall provided with the projecting connector part 7e of the main body 7a, as illustrated in FIG. 3, second locking parts 7f corresponding to the first locking parts 5k of the resinous member 5b of the shield plate 5 are formed so as to project from the inside face along the bottom wall of the main body 7a.

The cover 7c includes locking pieces 7g which are locked to locking projections (not illustrated) on both sidewalls of the main body 7a when closing the opening 7b of the main body 7a. The cover 7c is opened when the shield plate 5 is inserted into or withdrawn from the main body 7a through the opening 7b.

Next, the procedure for accommodating the shield plate 5 mounting the coil 3 in the main body 7a of the housing 7 will be described. First, it is performed to insert the shield plate 5 into the main body 7a through the opening 7b, from one long side of resinous member 5b projecting the first terminal connecting part 5e. Then, it is performed to insert the guide parts 5j and the press-fitting parts 51 of the resinous member 5b of the shield plate 5 into the guide grooves 7d of the main body 7a, allowing the guide grooves 7d to guide the insertion of the shield plate 5 into the main body 7a.

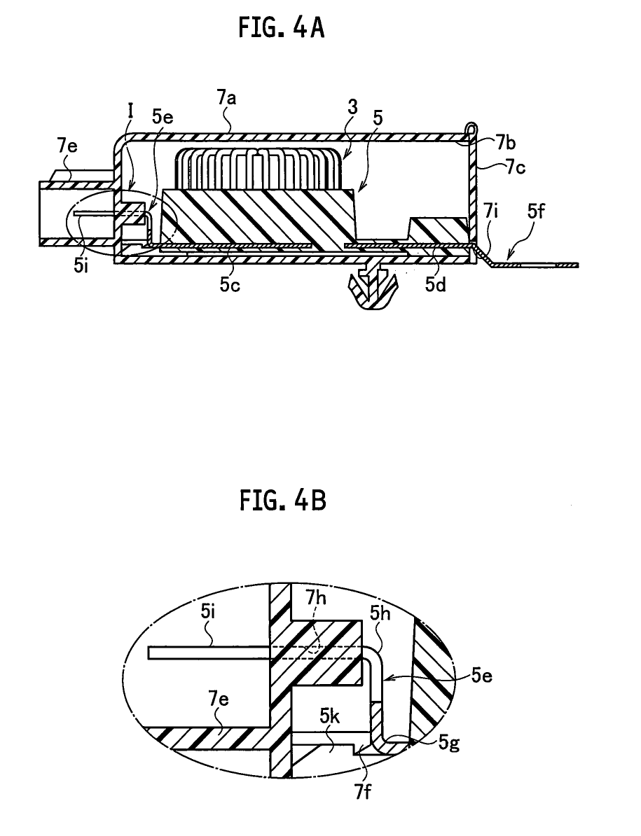

Under the accommodating condition that the shield plate 5 is inserted into the main body 7a till the shield plate 5 is fully accommodated as illustrated in FIG. 4A, each first locking part 5k of the shield plate 5 is locked to each second locking part 7f, as illustrated in FIG. 4B. Consequently, in the inserting direction X of the shield plate 5 into the main body 7a of the housing 7, the relative movement of the shield plate 5 to the housing 7 is restrained.

Further, under the accommodating condition of the shield plate 5 as illustrated in FIG. 4A, the respective press-fitting parts 51 of the resinous member 5b of the shield plate 5 come into pressure contact with both sidewalls on which the respective guide grooves 7d of the main body 7a are formed, so that the shield plate 5 is press-fitted in the opening 7b of the main body 7a, as illustrated in FIG. 5. In the inserting direction X of the shield plate 5 and also in the extending direction of the long sides of the opening 7b, consequently, the relative movement of the shield plate 5 to the housing 7 is restrained.

Additionally, under the accommodating condition of the shield plate 5 as illustrated in FIG. 4A, each tip portion 5i of the first terminal connecting part 5e penetrates through a through-hole 7h formed in the wall opposed to the opening 7c of the main body 7a and projects to an outside of the main body 7a, so that the tip portion 5i is exposed to an inside of the connector part 7e.

When the shield plate 5 is inserted into the main body 7a till the shield plate 5 is accommodated fully, the opening 7b of the main body 7a is closed by the cover 7c to complete the coil unit 1. In this condition, the second terminal connecting part 5f extends outside of the main body 7a through a cut-out part 7i formed in the cover 7c, as illustrated in FIG. 4A.

In the coil unit 1 according to the embodiment, the first terminal connecting part 5e is crank-shaped by the first bending part 5g and the second bending part 5h. Thus, under the condition that the shield plate 5 is accommodated in the main body 7a of the housing 7, the tip portion 5i of the first terminal connecting part 5e is arranged in a height position separated from the bottom wall of the main body 7a.

For this reason, it is possible to arrange the through-hole 7h of the main body 7a, through which the tip portion 5i of the first terminal connecting part 5e penetrates, and the connector part 7e at the center of the main body 7a in the extending direction of the short sides of the opening 7b of the main body 7a or in a position near the same center. Thus, it is possible to prevent the housing 7 from being shaped so that the connector 7e protrudes from the main body 7a.

In the coil unit 1 according to the embodiment, additionally, in the accommodating condition that the shield plate 5 mounting the coils 3 is accommodated in the inside space of the main body 7a of the housing 7, the tip portion 5i of the first terminal connecting part 5e is positioned in relation to the main body 7a, at the through-hole 7h through which the tip portion 5i of the first terminal connecting part 5e penetrates.

In such an accommodating condition, if the resinous member 5b of the shield plate 5 moves relatively to the housing 7 in the inserting direction X of the shield plate 5, stress will concentrate on the first bending part 5g and the second bending part 5h of the first terminal connecting part 5e, which are located between the tip portion 5i of the first terminal connecting part 5e positioned in relation to the main body 7a and the resinous member 5b.

However, in the coil unit 1 according to the embodiment, when inserting the shield plate 5 into the main body 7a till the accommodating condition, the first locking parts 5k of the shield plate 5 are locked to the second locking parts 7f of the main body 7a, so that the relative movement of the shield plate 5 to the main body 7a in the inserting direction X of the shield plate 5 is restrained by this locking.

Therefore, it is possible to prevent such a relative movement, which comes from stress concentration on the first bending part 5g and the second vending part 5h of the terminal connecting part 5e from being generated between the main body 7a and the shield plate 5 in the inserting direction X of the shield plate 5.

Note, the constitution where, under the accommodating condition of the shield plate 5 to the main body 7a, the shield plate 5 is press-fitted to the opening 7b of the main body so that the press-fitting parts 51 of the shield plate 5 make pressure contact with both sidewalls of the main body 7a, may be omitted.

However, in case of constructing a coil unit so that, like the coil unit 1 of the embodiment, the shield plate 5 is press-fitted to the opening 7b of the main body 7a under the accommodating condition of the shield plate 5 to the main body 7a, the relative movement of the shield plate 5 to the housing 7 in the inserting direction X of the shield plate 5 and in the extending direction of the long sides of the opening 7b is restrained at even pressure-contact points of the press-fitting parts 51. Thus, it is possible to prevent stress from concentrating on the first bending part 5g and the second vending part 5h of the terminal connecting part 5e furthermore.

In the coil unit 1 as the connector device according to the embodiment, additionally, the application of the connector device to a choke coil unit used in a vehicle, such as electric vehicle (EV) or hybrid vehicle (HEV: vehicle equipped with an engine and a motor generator) has been explained as an example. Nevertheless, the connector device according to the present application is broadly applicable to a case of extracting a part of busbar of a circuit body where a busbar is insert-molded in resinous material to expose the busbar to a connector part.

What is claimed is:

1. A connector device, comprising:
a circuit body in which a busbar is insert-molded in a resinous member and on which an electric component is mounted;
a housing defining an inside space in which the electric component on the circuit body is accommodated since the circuit body is inserted into the inside space through an opening of the housing;
a terminal connecting part provided in the busbar, the terminal connecting part projecting from the resinous member in a crank shape and having a tip portion extending along an inserting direction of the circuit body;
a connector part formed outside the housing to expose the tip portion penetrating through the housing under an accommodating condition that the circuit body is accommodated in the inside space;
a first locking part provided in the circuit body; and
a second locking part provided in the housing and being lockable to the first locking part, wherein
a relative movement of the circuit body to the housing along the inserting direction is restrained since the first locking part and the second locking part are locked to each other under the accommodating condition.

2. The connector device of claim 1, wherein
the circuit body further comprises a press-fitting part to be press-fitted into the opening under the accommodating condition.
